(19) United States
(12) Patent Application Publication
(10) Pub. No.: US 2007/0175402 A1
(43) Pub. Date: Aug. 2, 2007

(54) Animal litter and floor coverings for human shelters made from citrus peels and produced by method resulting in curled, rounded edges

(76) Inventor: Bradford James Richdale, Dana Point, CA (US)

Correspondence Address: ERIC HANSCOM, 7395 PORTAGE WAY, CARLSBAD, CA, 92011, US

(21) Appl. No.: 11/345,597

(22) Filed: Feb. 2, 2006

(51) Int. Cl. A01K 29/00

(52) U.S. Cl. 119/171

(57) ABSTRACT

This invention relates to a superior animal litter and floor coverings for human shelters, made solely from limed citrus peels. Because the litter uses one natural and recyclable product, it avoids the problems associated with other products made by processes which use non-recyclable products, require more than one substance to be mixed together, or rely upon wood or other potentially sharp objects which can injure the animal or pet. Instead, this product is produced by a process which takes citrus peels, a waste product so therefore one which is inexpensive and readily available, and processes it in an assembly line fashion with advanced machinery and processing techniques, such that it results in a naturally rounded object with no sharp ends or edges, which absorbs wetness from urine and feces and successfully masks the smell at the same time.

### CROSS REFERENCE TO RELATED APPLICATIONS

None.

### STATEMENT REGARDING FEDERALLY SPONSORED RESEARCH OR DEVELOPMENT

This invention was not federally sponsored.

### BACKGROUND OF THE INVENTION

This invention relates to a superior animal litter and floor coverings for human shelters from citrus peels. Because the litter consists of only one natural and recyclable product, it avoids the problems associated with other litters which use non-recyclable products, require more than one substance to be mixed together, or rely upon wood or other potentially sharp objects which can injure the animal or pet, stick to their fur or the gaps in between their toes. Instead, this product uses citrus peels, a waste product so therefore one which is inexpensive and readily available, which are processed in an assembly line fashion with advanced machinery and processing techniques, resulting in a naturally rounded object with no sharp ends or edges, which absorbs wetness from urine and feces and successfully masks the smell at the same time.

Animals have been domesticated for over 35,000 years. While some animals could be kept outside of the house or other enclosure, many types of animals were kept inside of a house or barn, either for protection of the animal or to protect the animal from the elements. Animals have been kept as pets for at least 4,000 years. While some pets have been, and still are, kept outside, the majority of pets were, and still are, kept inside the house. This has led to a major problem: how to minimize the damage to the house or barn from having the animal urinate or defecate inside the structure. An offshoot of this problem has been how to mask the odor of the urine or feces until they are removed from the structure, along with how to absorb the wetness such that the urine does not run all over the floor and the feces do not remain wet and difficult to pick up. An associated problem has been how to cover the floor of a human structure with a removable material that does not create health problems for the users of the structure.

The first attempt to solve these problems appears to have been to lay plant material such as hay and straw over the floor of the area where the animal (or human) was housed. While these types of plant material can successfully absorb some wetness and can be used to dry out feces somewhat, they do not perform these functions optimally. Another problem with use of hay, straw, alfalfa and other parts of the grain plants is that when wet, they tend to rapidly develop mildew and other undesirable molds and rot, thereby giving off an extremely foul odor and endangering the respiratory systems of those who breath in the mold spores. Indeed, over the past decade the dangers of toxic mold have become well known and their severity underscores the need for a bedding material that does not lend itself to rapidly developing mold. As such, grain plant materials, unless replaced regularly and often, quickly become more of a liability than an asset to the pet or animal keeper.

In the 1900's, the use of clay, bentonite, and other minerals became popular. They were cheap to manufacture in a pelletized form such that they not only absorbed wetness from urine and feces, but also clung to all sides of the feces thereby making it easier (and less offensive) to remove feces from a litter box. The flip side of mineral litters was that they could not be conveniently recycled or burned, and thus ended up adding to already overflowing landfills. As the world becomes more environmentally conscious, products which can be recycled are more and more important, and profitable. Thus, the older types of mineral animal litter have fallen out of popularity and have gradually lost shelf space to newer, “greener” products.

Recyclable animal litters have been available as alternatives to mineral and grain plant-based litters for quite some time. Some, such as the use of recycled paper or wood as animal litter, create a whole new set of problems as it is important to remove the inks, dyes, stains, and, in the case of cardboard and recycled plywood and other multi-layer woods, glues from the paper or wood before use as animal litter (or recycling the animal litter). The associated processes are expensive and time consuming, and frequently require toxic chemicals such as toluene or benzene to “clean up” the wood or paper, thereby creating an entirely new set of problems: namely, how to get rid of the chemicals used to clean up the wood or paper.

Animal litters made from wood products—not recycled wood—have also been manufactured. While the products have the advantage of being recyclable without substantial processing, they tend to be difficult to pelletize or deform, and often have sharp edges that may cut and injury an animal or pet, stick between its toes, cling to its fur, or at the very least make its bathroom experience a bit uncomfortable.

There are also several animal litters which have more than one natural ingredient, or have one or more natural ingredients combined with a thickening agent or other chemical compound. These litters can absorb wetness well and are recyclable, but often are costly due to the number of different compounds needed and the amount of mixing and preparation required.

The same problems faced many early dwellings inhabited by humans. Dirt floors turned muddy when humans or animals tracked in water from rain, rivers, lakes or watering holes. Early humans, and some modern-day primitive groups of humans, used and use straw and other natural grasses to cover the floor and absorb moisture, but this use, as with the use of such materials in animal stalls, causes major problems in that wet straw and other grasses may develop mildew and other undesirable molds and rot, thereby giving off an extremely foul odor and polluting the air with mold spores.

Thus, there has existed for a time period stretching back to the early caveperson days a lack of an animal litter or a covering for floors of primitive structures that successfully absorbs moisture from animal urine and feces, and does so without easily rotting or becoming moldy, is cheap and easy to produce, can be made from inexpensive and easy to find products, does not injure the animal using it, and can mask the smell of the animal's bathroom.

On such potential litter product is citrus peels. These are readily abundant for little or no cost at a variety of fruit juice plants, as they are considered basically a waste product of the juice extraction process, they absorb urine and feces well and have a pungent yet pleasant aroma, effectively masking the smell of animal urine and feces. Juicing operations are facing increased landfill costs if they wish to throw out the citrus peels, and finding farmers and ranchers who need the wet peels for animal food are becoming more and more scarce. Due to ever-growing environmental regulations, the legal and inexpensive disposal of citrus peels is expected to be even more difficult. Thus, the idea of using citrus peels for animal litter is a creative solution to two major problems: the juicing operation gets rid of a waste product and the litter manufacturer gets it starting product for little or no money.

The prior has several examples of attempts to resolve this problem. For example, Johnson in U.S. Pat. Nos. 4,386,580 and 4,465,019 describes methods of preparing pet litter from, among other compounds, citrus pulp, and methods of using said pet litter to deodorize animal waste. The current method is substantially more efficient and productive due to its superior mechanization and utilization of an assembly line with advanced machinery and precision drying techniques. US Patent Applications Nos. 20030205204 to Wang and 20040112298 to Buttersnack, and U.S. Pat. No. 6,860,223 to Buttersack (sic) disclose animal litters which use plant material, including citrus residue—similar to the current invention—but requires the addition of a primary sorbent from plant meal, grain germ, or some combination thereof. U.S. Pat. No. 5,605,114 to Peltenburg teaches an absorbent made from at least 50% dried vegetable pulp, but does not utilize the mechanized means of the current invention nor does it approach the issue of deodorizing the smell of animal feces and urine as does the current invention. U.S. Pat. No. 4,727,824 to Ducharme describes an animal litter utilizing, among other products, citrus pulp, but requires it to be pelletized before use. None of the prior inventions utilize a pelletizing and drying process that avoids leaving the sharp edges on the citrus peels, and many require the presence of additional additives, binders, and base materials in addition to the citrus peels, as opposed to the current invention which solely utilizes limed citrus peels.

Thus there has existed a long-felt need for a citrus peel-based animal litter which can be recycled, does not require the addition of other materials, is easy to manufacture, does not have sharp portions which may injure the animal or pet, successfully absorbs moisture from animal urine and feces, and masks their smell.

The current invention provides just such a solution by providing a product comprised of limed citrus peels to produce superior animal litter, or floor coverings for human structures with dirt floors or other flooring styles which would benefit from a removable covering. Because the invention is produced using one natural and recyclable product—limed citrus peels—it avoids the problems associated with other, more costly and less environmentally sound processes which use non-recyclable products, require more than one substance to be mixed together, or rely upon wood or other potentially sharp objects which can injure the animal or pet. Instead, this product is produced from citrus peels—mainly orange and grapefruit citrus peels—a waste product so therefore one which is inexpensive and readily available, which are processed in an assembly line fashion with advanced machinery and processing techniques, such that it results in a naturally rounded object with no sharp ends or edges, which absorbs wetness from urine and feces and successfully masks the smell at the same time.

### SUMMARY OF THE INVENTION

It is a principal object of the invention to provide an animal litter which can be recycled, is easy to manufacture, does not have sharp portions which may injure the animal or pet, and successfully absorbs moisture from animal urine and feces and masks their smell.

It is another object of the invention that the animal litter can be produced on an assembly line arrangement where each task is performed sequentially and with precision, thereby allowing for the creation of a standardized final product with known qualities.

It is an additional object of the invention that the litter can be used for cats, dogs, horses, llamas, alpacas, sheep, goats, guinea pigs, hamsters, snakes, lizards, frogs, toads, birds, pigs, and other barnyard or zoo animals, and pets.

It is a further object of the invention that the litter can be used as bedding or floor covering for primitive human habitation, such as backwoods cabins, and shelters in primitive countries.

It is a final object of this invention that the litter produced by mechanization and reliance upon solely one waste product (citrus peels) will be a superior animal litter, manufactured for less cost than is currently possible using the other available methods and materials used to produce litter.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### DETAILED DESCRIPTION OF THE INVENTION

The animal or human bedding litter as described in this patent is made by a method of processing citrus peels into the eventual product which be broken down into the following production cycle:

1. Citrus peels dumped into Peel Bin. The process begins with wet citrus peels being transported from a citrus juice processing plant, or other operation removing the juice form citrus fruit and leaving the peels as waste material, to the assembly line where they are initially dumped in a wet peel storage bin. The citrus peels can be some combination of grapefruit, orange, tangerine, pummelo, lemon, lime or another commercially popular citrus fruit which is made into juice. Most peel bins have vertical, carbon steel fronts with hydraulically operated doors, a caged ladder from the bottom to the top, and a catwalk across the top.

2. Peel Bin Discharge Conveyor. The wet peel storage bin has a series of augers that pull a measured amount of wet peels from the bottom of the bin and convey it to the limer on an ultra heavy duty, stainless steel conveyor. Some features of this conveyance system include Gatke hanger bearings, three-bolt drilling, and a variable-speed electric drive. The peel bin discharge conveyor is usually located high enough to allow the peels to drop directly off its end into the liming system.

3. Liming System. A lime screw conveyer or screw drive transport with a 1.5 hp motor with variable speed conveys the peels such that each conveyer belt section of wet peels passes through the limer, or lime hopper, which is a metal box which usually holds one or two bags of lime, at a set rate, thereby ensuring equal application of lime to all sections of wet peels. At the limer, a set amount of lime, usually ½% by weight, is added to the wet peels in liquid or powder form. The limer adds lime in a measured manner through use of a metering screw deposit mechanism.

4. Peel Shredder or Hammer Mill. After leaving the limer, a screw conveyer carries the limed peel to a shredder or hammer mill with a 75 hp motor, which shreds the peels into small pieces approximately ½ inches on a side, with a minimum of wasted fine material. In an alternative iteration of the invention, the eventual pellet is initially chopped by a horizontal rotor shredder. In either case, the cutting portions of the machinery are made of stainless steel. The size of the eventual piece can be modified by adjusting the number of cutting blades, the number of screens, and the sizes of the screens. The small size of the flakes facilitates the pressing process further down the assembly line.

5. Reaction Conveyor. Shredded peel drops directly into a slightly inclined Reaction Conveyor. This conveyor is sized to allow approximately 10 to 12 minutes dwell time. It is of stainless steel construction and features a notched blade screw. After being shredded, the peel flakes are carried by a Reaction Screw Drive, which is a large, slow moving, carbon steel screw conveyor that is specifically designed to slowly move the limed peel flakes through a given distance, providing adequate time—usually 10-12 minutes—for the peel flakes and lime to chemically react, thereby causing the limed peel flakes to release water very easily during the pressing operation. The lime catalyzes a chemical reaction between the lime and the peel that breaks down the cell wall structure of the peel which facilitates moisture removal during the pressing and drying operations. Indeed, were the cell walls of the citrus peels not broken down, only those cells whose cells walls were crushed or cut would release a substantial quantity of water during the next phase, which is the pressing operation. The Reaction Screw Drive is powered by a 10 hp motor with a reducer, which is a device which changes the speed at which the conveyer belt moves to a lower rate.

6. Elevating Conveyor. The Reaction Screw Drive deposits the limed peel flakes on a Second Screw Drive, powered by a 5 hp motor with reducer.

7. Presses. The Second Screw Drive then transports the limed peel flakes to a series of two Peel Presses or extractors, each powered by 20 hp motors, which press the limed peel to remove as much water as possible. The extracted liquid, or liquor, as it is called, is removed from the limed peel flakes in the Peel or Mash Presses. The liquid in some operations is eventually distilled into industrial-grade molasses which is a common additive to cattle feed, but in other cases the liquid is discarded. With respect to the citrus pellets relating to this invention, the liquid is, optionally and preferably, not added back into the pressed peel.

8. Dryer Screw Conveyer. The remaining pressed flakes are then transported via a stainless steel Screw Conveyor, which is powered with a 5 hp motor with reducer, and loaded onto a Screw Conveyor To Dryer, also powered with a 5 hp motor with reducer, and loaded into the Dryer. This screw conveyor has an adjustable, variable speed drive to control the feed rate at which it loads pressed peel pellets into the dryer.

9. Dryer. Inside the Dryer, the pressed flakes are dried by a first Combustion Fan (20 hp fan), and then a second Combustion Fan (10 hp fan) both of which have burners with dampers and valves, along with a steam heater for the oil. The dryer temperatures begin at around 265 degrees Fahrenheit as a load of peels begins the drying process, and then drops down to approximately 230 degrees Fahrenheit, which is the optimum operating temperature. The dried flakes are then dumped into a Drying Cylinder, which is a long cylinder which is rotated by a 40 hp motor with a reducer and further dried by four fans powered by 30 hp motors. The Drying Cylinder is constructed from a carbon steel shell with firebrick lining, and produces an end yield of dried citrus pellets of approximately 10% moisture (as opposed to the 80% or more moisture content for peels in the initial phase of the operation).

One of the unique features of this invention is the drying process which causes the edges of the chopped citrus peel, as produced by the prior steps of this process, to curve inward upon itself, thereby naturally “pelletizing” itself and removing any sharp edges which could otherwise cut an animal's feet, wedge into the spaces between an animal's toes, or cling to an animal's fur. Without this unique drying feature, the chopped and dried pieces of citrus peels would have to be tumbled upon a rough surface such as sandpaper or have some other dust-producing process performed upon it. Such a process would increase the production cost and production time, decrease the eventual yield per unit volume of peels as a substantial portion of the peel would have to be “sanded away”, and result in the production of a substantial amount of dust which would be an unhealthy mixture of citrus peels and lime. It should be noted that aerated lime is an extremely hazardous material which has been used as a weapon of war in the past. Thus, creating a rounded piece of citrus peel is a substantial improvement over the alternatives.

10. Flake Screw Transportation. The dried flakes are then conveyed along a Flake Horizontal Screw and a Flake Incline Screw, both powered by 3 hp motors with reducers, to a Flake Suction Fan, powered by a 20 hp motor. The Flake Suction Fan removes dust and other debris from the dried pellets before they are conveyed away on a Flake Screw Drive. The dust is collected in a Dust Collector. A carbon steel screw conveyor then transports the peel to the cooling reel and bagger.

11. Cooling Reel. In this stage the hot, dried pellets are cooled-by being tumbled in a large diameter drying machine with uses an outside air source to carry the heat out of the cooling reel through evaporative cooling. This process further reduces the moisture content of the pellets to around 1%.

12. Bagging System. After cooling, the pellets are then fed through a surge hopper and a semi-automatic weighing and bagging unit. This system includes a surge hopper and a semi-automatic weighing and bagging unit which includes an adjustable discharge holding and weighing bin, a weighing device, a bag holder to hold the bags open to receive the pellets, and a sewing device the close up the bags. An optional arrangement is to load the pellets into a container truck for transportation to a bagging plant located outside of the peel processing plant.

What I claim is:

1. A litter suitable for use as animal litter or for bedding in primitive human shelters, comprising: obtaining a plurality of wet citrus peels and an amount of lime, where, the plurality of wet citrus peels are subjected to a process of manufacture comprising the following steps: cutting, shredding or chopping the peels into a plurality of pieces approximately ½″ on all sides, pressing the pieces to remove water, drying the peels to remove more water, and packing the resulting peels in bags for retail sales, where, the limed peels constitute the only ingredient to the litter.

2. The litter of claim 1, where the method of producing the litter additionally comprising the following steps:
A. A plurality of wet citrus peels are transported to an assembly line where the peels are initially dumped in a wet peel storage bin,
B. The peels are removed from the wet peel storage bin by a plurality of augers, set up to be a series called the Peel Bin Discharge Conveyor, creating a conveyor belt out of the wet peel storage bin.
C. An amount of lime is added by a limer with a metering screw deposit mechanism which adds approximately ½% by weight of lime to the peels during the time they are being moved upon the Peel Bin Discharge Conveyor,
D. The peels are transported into a Peel Shredder with cuts the peels into a plurality of pieces approximately ½ inches on a side,
E. After being processed in the Peel Shredder, the pieces are transported to a dryer, along a reaction conveyer, which is a slow-moving conveyor belt moving at a speed which allows the pieces to react with the quantity of lime to break open a plurality of cell walls within each piece,
F. The pieces are then transported to a Press, which physically presses a certain amount of water out of the pieces, resulting in two compounds: a plurality of flakes and a quantity of liquid,
G. The liquid is removed from the process,
H. The flakes are conveyed to a dryer by a conveyer with a variable rate of speed, such that a set amount of flakes are transported to the dryer per unit time,
I. The dryer removes a quantity of water from the flakes, resulting in flakes with a moisture content of approximately 10%,
J. During the time a flake spends in the dryer, the drying process causes a plurality of edges on each flake to curl up and back in upon itself, thereby turning the flakes from a basically flat shape to a basically round shape,
K. The plurality of pellets produced by the drying process are then transported by a flake screw and flake incline screw to a flake suction fan which removes dust and other debris from the pellets,
L. The pellets are then transported by a conveyor belt to a cooling reel, where the pellets are cooled by a quantity of air procured from outside the cooling reel and pumped inside by one or more pumps, such that the air picks up a quantity of heat and moisture from the pellets and conveys the same outside, resulting in pellets with a moisture content of approximately 1%,
M. The pellets are then poured into a plurality of bags, and the tops of the bags are sewn shut by one or more machines capable of sewing a bag shut.

3. The litter of claim 2, where, the process of making the litter additionally includes a limitation that the dryer temperature is approximately 230 degrees Fahrenheit.

4. The litter of claim 2, where, the drying process causes the edges of the pieces of citrus peel to curl up, resulting in a pellet of citrus peel which has rounded edges.

5. The litter of claim 4, where the amount of lime added to the citrus peels is less than ½% by weight.

6. The litter of claim 4, where the amount of lime added to the citrus peels is more than ½% by weight.

7. The litter of claim 4, where the amount of lime added to the citrus peels is approximately ½% by weight.

8. The litter of claim 1, where the method of producing the litter additionally comprising the following steps:
A. A plurality of wet citrus peels are transported to an assembly line where the peels are initially dumped in a wet peel storage bin,
B. The peels are removed from the wet peel storage bin by a plurality of augers, set up to be a series called the Peel Bin Discharge Conveyor, creating a conveyor belt out of the wet peel storage bin.
C. An amount of lime is added by a limer with a metering screw deposit mechanism which adds approximately ½% by weight of lime to the peels during the time they are being moved upon the Peel Bin Discharge Conveyor,
D. The peels are transported into a Hammer Mill with cuts the peels into a plurality of pieces approximately ½ inches on a side,
E. After being processed in the Peel Shredder, the pieces are transported to a dryer, along a reaction conveyer, which is a slow-moving conveyor belt moving at a speed which allows the pieces to react with the quantity of lime to break open a plurality of cell walls within each piece,
F. The pieces are then transported to a Press, which physically presses a certain amount of water out of the pieces, resulting in two compounds: a plurality of flakes and a quantity of liquid,
G. The liquid is removed from the process,
H. The flakes are conveyed to a dryer by a conveyer with a variable rate of speed, such that a set amount of flakes are transported to the dryer per unit time,
I. The dryer removes a quantity of water from the flakes, resulting in flakes with a moisture content of approximately 10%,
J. During the time a flake spends in the dryer, the drying process causes a plurality of edges on each flake to curl up and back in upon itself, thereby turning the flakes from a basically flat shape to a basically round shape,
K. The plurality of pellets produced by the drying process are then transported by a flake screw and flake incline screw to a flake suction fan which removes dust and other debris from the pellets,
L. The pellets are then transported by a conveyor belt to a cooling reel, where the pellets are cooled by a quantity of air procured from outside the cooling reel and pumped inside by one or more pumps, such that the air picks up a quantity of heat and moisture from the pellets and conveys the same outside, resulting in pellets with a moisture content of approximately 1%,
M. The pellets are then poured into a plurality of bags, and the tops of the bags are sewn shut by one or more machines capable of sewing a bag shut.

9. The litter of claim 8, where, the process of making the litter additionally includes a limitation that the dryer temperature is approximately 230 degrees Fahrenheit.

10. The litter of claim 8, where, the drying process causes the edges of the pieces of citrus peel to curl up, resulting in a pellet of citrus peel which has rounded edges.

11. The litter of claim 8, where the amount of lime added to the citrus peels is less than ½% by weight.

12. The litter of claim 8, where the amount of lime added to the citrus peels is more than ½% by weight.

13. The litter of claim 8, where the amount of lime added to the citrus peels is approximately ½% by weight.

14. The litter of claim 1, where the citrus peel contains peels from one or more of the following citrus: orange, grapefruit, lemon, lime, pummelo, tangerine, tangelo, and kumquat.

15. The litter of claim 1, where, the drying process causes the edges of the pieces of citrus peel to curl up, resulting in a pellet of citrus peel which has rounded edges.

16. The litter of claim 15, where, the purpose for which the pellet is used as animal litter.

17. The litter of claim 16, where, the animal for which the litter is intended is one or more of the following: horse, dog, cat, bird, hamster, guinea pig, snake, lizard, frog, toad, alpaca, llama, sheep, goat, bird, pig, or other common barnyard or zoo animal, or pet.

18. The litter of claim 16, where, the purpose for which the pellet is used as a bedding or floor covering for primitive human shelters and houses.

19. A method of using litter suitable for use as animal litter or for bedding in primitive human shelters, comprising the steps of: first obtaining a litter produced by a method of obtaining a plurality of wet citrus peels and an amount of lime, where the amount of lime constitutes approximately one half of one percent of the wet citrus peels by weight, where, the plurality of wet citrus peels are subjected to a process of manufacture comprising the following steps: cutting, shredding or chopping the peels into a plurality of pieces approximately ½″ on all sides, pressing the pieces to remove water, drying the peels to remove more water, and packing the resulting peels in bags for retail sales, where, the limed peels constitute the only ingredient to the litter, second, applying the litter to the floor of the area in which the litter is desired to be used, and third, removing the litter at a desired time.

20. A method of using litter suitable for use as animal litter in boxes or trays common to the pet industry, comprising the steps of: first obtaining a litter produced by a method of obtaining a plurality of wet citrus peels and an amount of lime, where the amount of lime constitutes approximately one half of one percent of the wet citrus peels by weight, where, the plurality of wet citrus peels are subjected to a process of manufacture comprising the following steps: cutting, shredding or chopping the peels into a plurality of pieces approximately ½″ on all sides, pressing the pieces to remove water, drying the peels to remove more water, and packing the resulting peels in bags for retail sales, where, the limed peels constitute the only ingredient to the litter, second, applying the litter to the floor of the box or tray in which the litter is desired to be used, and third, removing the litter at a desired time.
